(19) United States
(12) Patent Application Publication
(10) Pub. No.: US 2014/0318941 A1
(43) Pub. Date: Oct. 30, 2014

(54) KEYBOARD WITH PIVOTING KEY SUPPORTING PORTION

(71) Applicants: HON HAI PRECISION INDUSTRY CO., LTD., New Taipei (TW); Fu Tai Hua Industry (Shenzhen) Co., Ltd., Shenzhen (CN)

(72) Inventor: YAN-BANG CAO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/973,983

(22) Filed: Aug. 22, 2013

(30) Foreign Application Priority Data
Apr. 30, 2013 (CN) 2013101551774

(51) Int. Cl. H01H 13/84

(52) U.S. Cl. CPC H01H 13/84
USPC 200/5 A

(57) ABSTRACT

A keyboard with a key supporting portion which is retractable and ergonomically suited for typing activities includes a hollowed main body. The key supporting portion has one end pivotally connected to the hollowed main body, and one or more latching holes at the other end. A latching member is slidably received in the space within the hollowed main body, and the latching member has a free end that is slidable into a latching hole, thereby locking the key supporting portion to the main body. A fingertip-operated handle transfers a releasing force to the latching member, thereby freeing the key supporting portion and allowing it to tilt upwards under spring pressure.

### BACKGROUND

1. Technical Field

The present disclosure relates to a keyboard with a detachable key supporting portion.

2. Description of Related Art

Keyboards are commonly used input devices. Many keyboards of different structures have been proposed. However, a keyboard which can be adjusted for ergonomic preference with minimal effort and which still packs down to a thin profile is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a keyboard according to one embodiment.

FIG. 2 is an isometric, exploded view of the keyboard of FIG. 1.

FIG. 3 is an enlarged view of the portion III of FIG. 2.

FIG. 4 is a partial assembled view of the keyboard of FIG. 1, with a key supporting portion omitted.

FIG. 5 is cross-sectional view of the keyboard of FIG. 4, taken along line V-V of FIG. 4.

FIG. 6 is an enlarged view of the portion VI of FIG. 5.

### DETAILED DESCRIPTION

Embodiments of the present disclosure will be described with reference to the accompanying drawings.

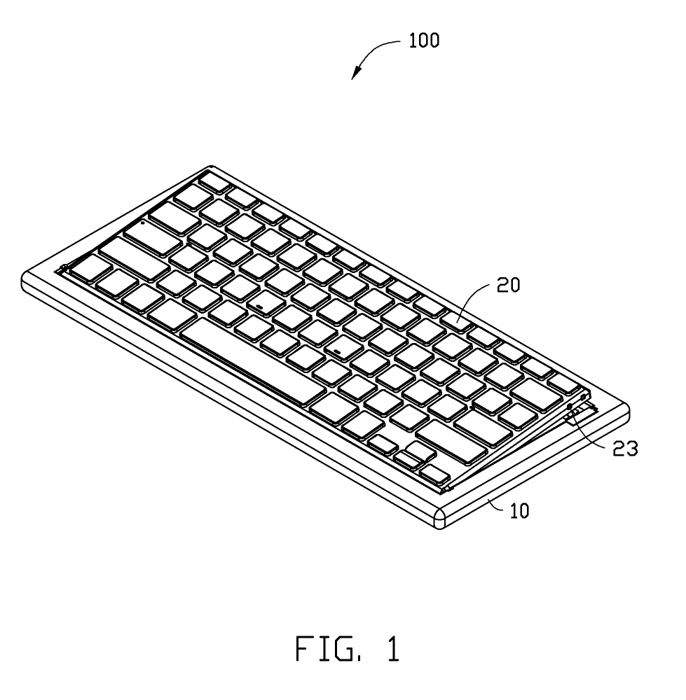

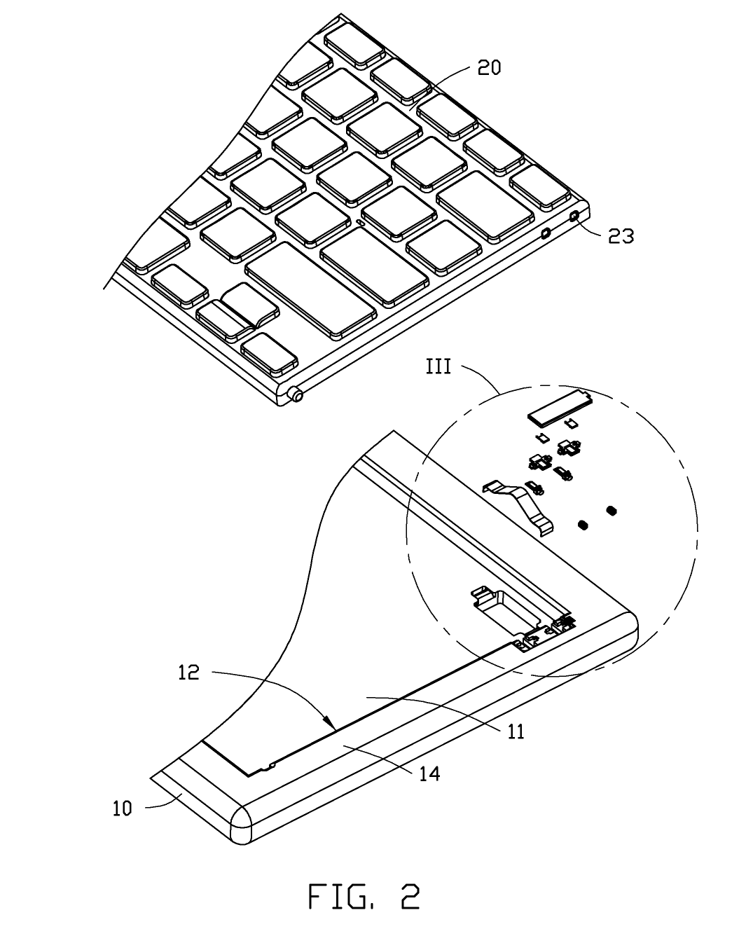

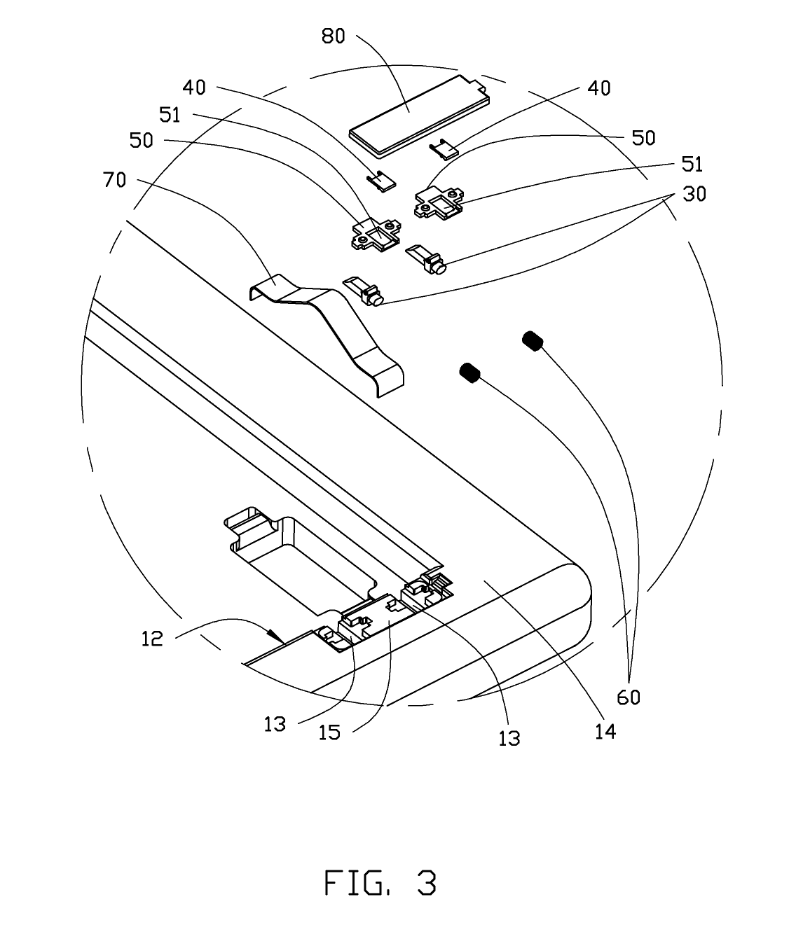

Referring to FIGS. 1-3, a keyboard 100 includes a main body 10 and a key supporting portion 20. The main body 10 defines a recess 11 that receives the key supporting portion 20. The top surface 14 of the main body 10 defines a recess 15, and a receiving space 13 is defined in the bottom of the recess 15 and a side surface 12 of the recess 11.

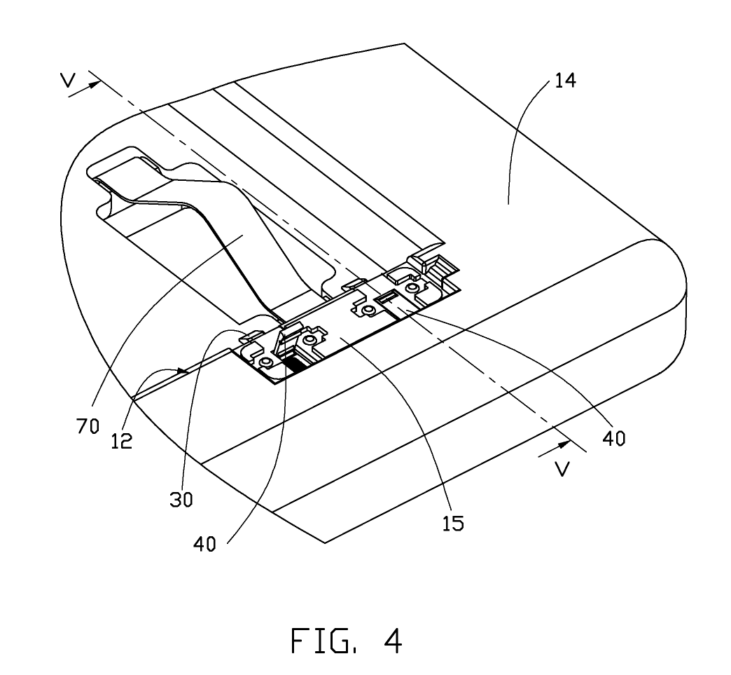

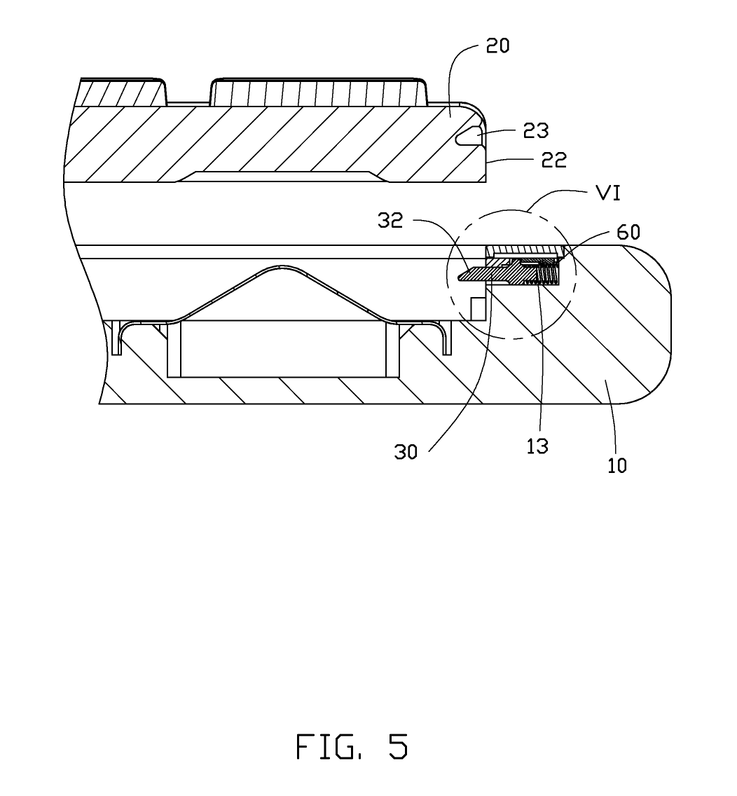

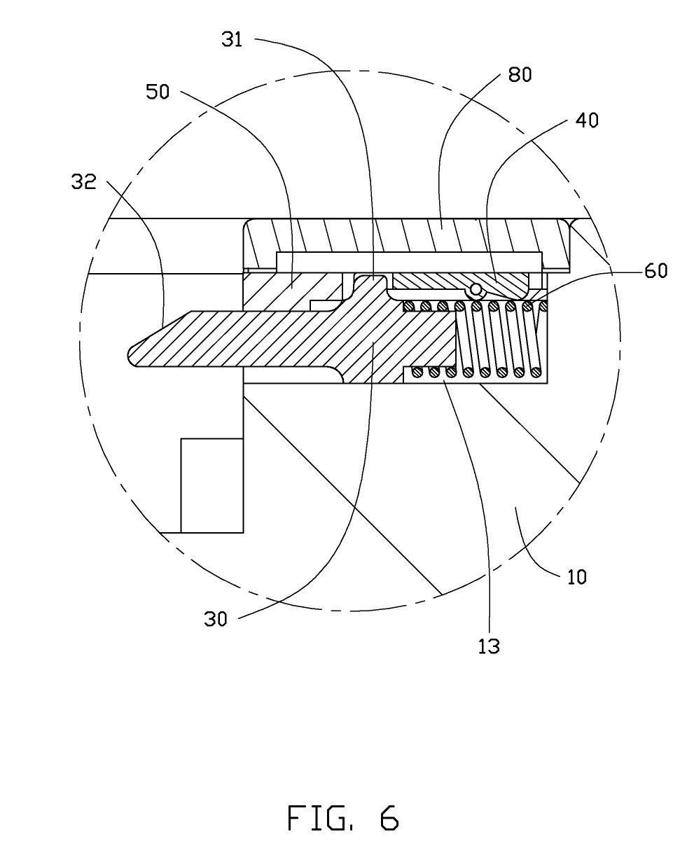

Referring to FIGS. 4-6, the key supporting portion 20 includes an end 21 pivotally connected to the main body 10. A side surface 22, distanced from the end 21, defines a latching hole 23. A latching member 30 is slidably received in the receiving space 13, and a free end 33 of the latching member 30 protrudes from the side surface 12 of the recess 11. When the free end 33 is received in the latching hole 23, the key supporting portion 20 is retracted into and locked to the main body 10.

The keyboard 100 further includes a handle 40 including one end rotatably connected to the latching member 30. The handle 40 can be rotated to an open position (FIG. 4), and a user can pull the handle 40 to cause the latching member 30 to completely move into the receiving space 13. That is, the handle 40 can be pulled by a user, causing the free end 33 of the latching member 30 to move out of the latching hole 23, thereby freeing the key supporting portion 20 from the limitation of the latching member 30.

In the embodiment, a cap 50 is secured to the main body 10 and covers the receiving space 13. The cap 50 defines an opening 51. The latching member 30 includes a projection portion 31 that is received in the opening 51. The projection portion 31 can contact one end of the opening 51, thereby preventing the latching member 30 from moving out of the receiving space 13.

In the embodiment, the keyboard 100 further includes a resilient member 60 (e.g., a coil spring) received in the receiving space 13. The resilient member 60 constantly pushes against the latching member 30, thereby maintaining the free end 33 of the latching member 30 in the latching hole 23.

In the embodiment, the latching member 30 includes a ramped surface (oblique surface 32). The oblique surface 32 is configured in such a way that the key supporting portion 20 bears down on the oblique surface 32 and thus pushes the latching member 30 to move into the receiving space 13 when the key supporting portion 20 is rotated toward the main body 10.

In the embodiment, the keyboard 100 further includes an elastic member 70 secured to the main body 10. The elastic member 70 applies an upward pushing force to the key supporting portion 20, pushing the key supporting portion 20 away from the main body 10 when the free end 33 of the latching member 30 moves out of the latching hole 23.

In the embodiment, the keyboard 100 further includes a cover 80 that covers the recess 15. The cover 80 must first be removed by a user and the handle 40 then rotated and pushed.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A keyboard comprising:
a main body defining a recess, the recess comprising a side surface that defines a receiving space;
a key supporting portion comprising one end pivotally connected to the main body, the key supporting portion defining a latching hole;
a latching member slidably received in the receiving space, the latching member comprising a free end that is slidable into the latching hole, thereby locking the key supporting portion to the main body;
a handle rotatably connected to the latching member, the handle being configured to transfer a pulling force from a user to the latching member, causing the free end of the latching member to move out of the latching hole, thereby freeing the key supporting portion from the limitation of the latching member.

2. The keyboard according to claim 1, further comprising an elastic member secured to the main body, wherein the elastic member is configured to apply a pushing force to the key supporting portion, thereby pushing the key supporting portion to rotate when the free end of the latching member moves out of the latching hole.

3. The keyboard according to claim 1, further comprising a resilient member arranged in the receiving space, wherein the resilient member is configured to apply a pushing force to the latching member, thereby retaining the free end in the latching hole.

4. The keyboard according to claim 3, wherein the resilient member is a coil spring.

5. The keyboard according to claim 3, wherein the latching member comprises an oblique surface, the oblique surface is configured in such a way that the key supporting portion pushes the latching member to move into the receiving space when the key supporting portion is rotating toward the main body and contacting the oblique surface.

6. The keyboard according to claim 1, further comprising a cap, wherein the main body comprises a top surface that defines a recess, the receiving space is defined in a bottom surface of the recess, the cap covers the receiving space and defines an opening, the latching member comprises a projection portion, the projection portion is received in the opening, and the projection portion is configured to contact one end of the opening, thereby preventing the latching member from moving out of the receiving space.
